(19) United States
(12) Patent Application Publication
(10) Pub. No.: US 2025/0073803 A1
(43) Pub. Date: Mar. 6, 2025

(54) ULTRAPORTABLE WELDING DEVICES

(71) Applicant: Illinois Tool Works Inc., Glenview, IL (US)

(72) Inventor: Beau Gellings, Appleton, WI (US)

(21) Appl. No.: 18/820,581

(22) Filed: Aug. 30, 2024

Related U.S. Application Data
(60) Provisional application No. 63/579,819, filed on Aug. 31, 2023.

(51) Int. Cl. B23K 9/12

(52) U.S. Cl. CPC B23K 9/124

(57) ABSTRACT

Disclosed handheld welding devices include: an energy storage device; power conversion circuitry configured to convert input power from the energy storage device to output welding power; a wire feeder configured to deliver welding wire and/or a gas valve configured to control flow of gas from a gas source; a front assembly configured to conduct the welding power to a welding electrode, wherein the front assembly is swappable between two or more of a wire-fed welding process, a stick welding process, or a tungsten electrode welding process; control circuitry configured to control the power conversion circuitry and the at least one of the wire feeder or the gas valve based on the configured one of the two or more welding processes, to selectively provide the welding power and at least one of the welding wire or the gas to the front assembly in response to an input device; and a housing.

### RELATED APPLICATIONS

The present application claims the benefit of U.S. Provisional Patent Application Ser. No. 63/579,819, filed Aug. 31, 2023, entitled “ULTRAPORTABLE WELDING DEVICES.” The entirety of U.S. Patent Application Ser. No. U.S. Provisional Patent Application Ser. No. 63/579,819 is expressly incorporated herein by reference.

### FIELD OF THE DISCLOSURE

This disclosure relates generally to welding systems and, more particularly, to ultraportable welding devices.

### BACKGROUND

Welding power supplies are typically powered using power sources such as utility or mains power or engine-driven generator power. Battery-powered welding sources have been offered, but take the form of conventional welding power systems which are adapted in various ways to have power supplied by batteries.

### SUMMARY

Ultraportable welding devices are disclosed, substantially as illustrated by and described in connection with at least one of the figures, as set forth more completely in the claims.

### BRIEF DESCRIPTION OF THE DRAWINGS

FIG. 1 illustrates an example ultraportable welding device, in accordance with aspects of this disclosure.

FIG. 2 is a block diagram of example implementation of the ultraportable welding device of FIG. 1.

FIGS. 3A-3D illustrate the example ultraportable welding device connected to different front assemblies to perform different types of welding processes using the ultraportable welding device.

The figures are not necessarily to scale. Wherever appropriate, similar or identical reference numerals are used to refer to similar or identical components.

### DETAILED DESCRIPTION

Conventional welding equipment can require a substantial amount of effort to set up, particularly when the welding equipment must be disassembled and moved to the location of a weld to be performed. In cases in which a short, brief weld is to be performed, the assembly and configuration may be considerably longer than the arc-on welding time.

Disclosed example ultraportable welding devices allow an operator to rapidly set up and perform a welding operation. Some example ultraportable welding devices are powered by battery (or other energy storage device), and/or have a gun-shaped or torch-shaped form factor which provides ergonomic handling and use of the ultraportable welding devices. The ultraportable welding device may carry and/or be connected to each of the consumable elements required to perform the desired welding operation, such as electric power and wire and/or shielding gas. A welding operator may simply grab the ultraportable welding device, carry the ultraportable welding device to the site of the weld, connect a work lead of the welding device to the workpiece, and begin welding.

Additionally, disclosed example ultraportable welding devices are quickly and easily convertible between different types of welding processes, such as wire-fed welding processes, stick welding processes, and/or tungsten electrode welding processes, by an exchange of front assemblies and changes in control of power conversion circuitry. Different front assemblies may include and/or interface with different connections present on a housing of the ultraportable welding device, such an power, gas, and/or wire connections.

Example ultraportable welding devices are advantageously deployed even in remote locations, in which conventional welding power supplies may require extended power cords to be supplied with the requisite power, and/or confined locations, in which there may be little room for welding equipment in addition to the operator.

According to aspects of the disclosure, an example handheld welding device includes: an energy storage device; power conversion circuitry configured to convert input power from the energy storage device to output welding power; at least one of: a wire feeder configured to deliver welding wire; or a gas valve configured to control flow of gas from a gas source; a front assembly configured to conduct the welding power to a welding electrode, wherein the front assembly is swappable between two or more of a wire-fed welding process, a stick welding process, or a tungsten electrode welding process; control circuitry configured to control the power conversion circuitry and the at least one of the wire feeder or the gas valve based on the configured one of the two or more welding processes, to selectively provide the welding power and at least one of the welding wire or the gas to the front assembly in response to an input device; and a housing, in which the power conversion circuitry, the at least one of the wire feeder or the gas valve, and the control circuitry are integral to the housing, and the energy storage device is integral or detachably attached to the handheld welding device.

In some example handheld welding devices, the housing includes a handle and a connector connecting the handle to the front assembly. In some example handheld welding devices, the energy storage device is attached external to the housing. Some example handheld welding devices further include a wire supply attached external to the housing.

Some example handheld welding devices further include a wire supply separate from and coupled to the handheld welding device, in which the wire feeder is configured to pull the welding wire from the wire supply. In some example handheld welding devices, the front assembly includes a gas nozzle, a diffuser, and a contact tip, wherein the diffuser and the contact tip provide a current path from the power conversion circuitry to the welding wire.

In some example handheld welding devices, the front assembly is configured to alternately hold a stick electrode. In some example handheld welding devices, the front assembly is replaceable with a stick electrode holding assembly. In some example handheld welding devices, the front assembly is replaceable with a tungsten electrode holding assembly.

Some example handheld welding devices further include polarity reversing circuitry configured to control a polarity output by the power conversion circuitry. Some example handheld welding devices further include one or more input devices configured to control at least one of a welding process, an amperage parameter, a voltage parameter, or a wire feed speed parameter. In some example handheld welding devices, the control circuitry is configured to determine at least one weld parameter based on a selection of a second welding parameter via the one or more input devices. Some example handheld welding devices further include a power input configured to receive input power from a power source, and a preregulator configured to convert the input power from the power source to a DC power, and to provide the DC power to the power conversion circuitry.

According to some aspects of the disclosure, example handheld welding devices include: an energy storage device; power conversion circuitry configured to convert input power from the energy storage device to output welding power; a wire feeder configured to deliver welding wire; a front assembly configured to conduct the welding power to a welding electrode, wherein the front assembly is swappable between two or more of a wire-fed welding process, a stick welding process, or a tungsten electrode welding process; control circuitry configured to control the power conversion circuitry based on the configured one of the two or more welding processes, to selectively provide the welding power to the front assembly in response to an input device; and a housing, wherein the power conversion circuitry, the wire feeder, and the control circuitry are integral to the housing, and the energy storage device is integral or detachably attached to the handheld welding device.

In some example handheld welding devices, the housing includes a handle and a connector connecting the handle to the front assembly. In some example handheld welding devices, the energy storage device is attached external to the housing. Some example handheld welding devices further include a wire supply attached external to the housing.

Some example handheld welding devices further include a wire supply separate from and coupled to the handheld welding device, in which the wire feeder is configured to pull the welding wire from the wire supply. In some example handheld welding devices, the front assembly includes a gas nozzle, a diffuser, and a contact tip, wherein the diffuser and the contact tip provide a current path from the power conversion circuitry to the welding wire.

In some example handheld welding devices, the front assembly is configured to alternately hold a stick electrode. In some example handheld welding devices, the front assembly is replaceable with a stick electrode holding assembly. As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “bidirectional DC-DC converter” refers to any bidirectional circuit topology that converts voltage up and/or down in a first direction and converts voltage up and/or down in a second direction. Example bidirectional DC-DC converters include buck-boost and/or boost-buck topologies, a SEPIC converter, a Ćuk converter, or the like. For example, a bidirectional DC-DC converter may refer to a DC-DC converter that boosts voltage in one direction and bucks voltage in the opposing direction.

As used herein, the term “recognized battery unit” refers to a battery unit that is approved, authorized, and/or otherwise has identifiable minimum characteristics, such as charge state, nominal voltage, minimum voltage, maximum voltage, and/or charge capacity. Recognition can occur through signaling, measurement, and/or any other mechanism.

As used herein, a “circuit” includes any analog and/or digital components, power and/or control elements, such as a microprocessor, digital signal processor (DSP), software, and the like, discrete and/or integrated components, or portions and/or combinations thereof.

As used herein, a “welding electrode” includes, but is not limited to, welding wire, tungsten welding electrodes, and/or stick electrodes.

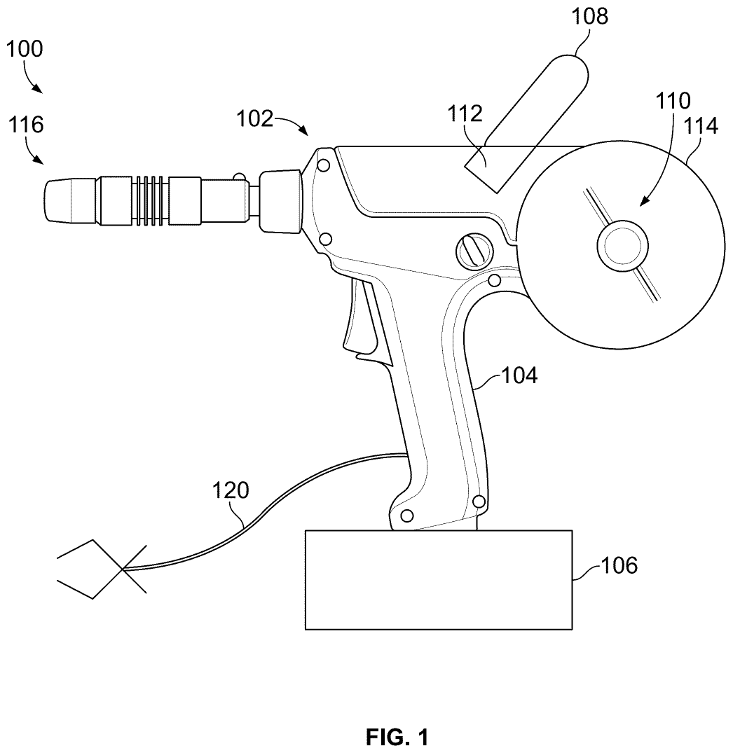

FIG. 1 illustrates an example ultraportable welding device 100. The ultraportable welding device 100 is configured to allow a weld operator to quickly and conveniently perform welds in remote locations. The example ultraportable welding device 100 of FIG. 1 includes a housing 102 which includes a handle 104 for manipulation by the weld operator.

The housing 102 provides for attachment of an energy storage device 106, a gas source 108, and/or a welding wire source 110. The example energy storage device 106 is a battery, but may be implemented using an ultracapacitor, a supercapacitor, and/or any other type of energy storage which is capable of sufficient power density and discharge rates to support the desired weld operations. The energy storage device 106 is detachably attached to the housing 102, to allow for removal of an energy storage device for charging, and/or swapping of a depleted energy storage device for a charged energy storage device. In other examples, the energy storage device 106 is integral to the housing 102.

The example gas source 108 of FIG. 1 is a removable gas (e.g., carbon dioxide (CO2)) cartridge. To receive the gas source 108, the housing 102 includes a gas port 112, which may receive the gas source 108 and/or lock the gas source 108 from inadvertent removal. The delivery of gas from the gas source 108 may be controlled using a gas valve, which may enable and disable gas delivery and, in some examples, controls a flow rate at which the gas is delivered from the gas source 108.

The welding wire source 110 holds a length of welding wire and supplies the welding wire (e.g., unspools the wire) to a wire feed assembly within the housing 102. The wire feed assembly delivers welding wire from the welding wire source 110 for wire-fed welding processes. The welding wire source 110 may be held on a spool holder 114 attached to the housing 102. The spool holder 114 may be detachable from the housing 102 or integral to the housing 102.

In some examples, due to the heavier weights of the welding wire source 110 and the energy storage device 106 compared with other elements of the ultraportable welding device 100, the welding wire source 110 and the energy storage device 106 may be distributed with respect to the handle 104 in an ergonomic way (e.g., to achieve a center of gravity within the handle 104), which reduces the fatigue on the operator of the ultraportable welding device. While an example arrangement of the welding wire source 110 and the energy storage device 106 is illustrated in FIG. 1, other example arrangements may be selected based on the positioning of other components, the weights of the welding wire source 110 and the energy storage device 106, and/or the shape of the housing 102 and/or the handle 104. For example, the welding wire source 110 may be provided on a separate wire source, which may be wearable by the operator. In some such examples, the separate wire source includes a wire feeder, which may operate as an assisting wire feeder or a primary wire feeder, allowing the wire feeder 218 to be omitted or detached from the housing 102.

The ultraportable welding device 100 further includes a swappable front assembly 116 which is connected to the housing 102 via a connector. The swappable front assembly 116 is swappable between two or more of a wire-fed welding process (e.g., gas metal arc welding (GMAW), flux cored arc welding (FCAW), etc.), a stick welding process (e.g., shielded metal arc welding (SMAW)), or a tungsten electrode welding process (e.g., gas tungsten arc welding (GTAW)). Each type of welding process that may be swappable uses some combination of electric power supplied by the energy storage device 106, shielding gas supplied by the gas source 108, and/or welding wire supplied by the welding wire source 110.

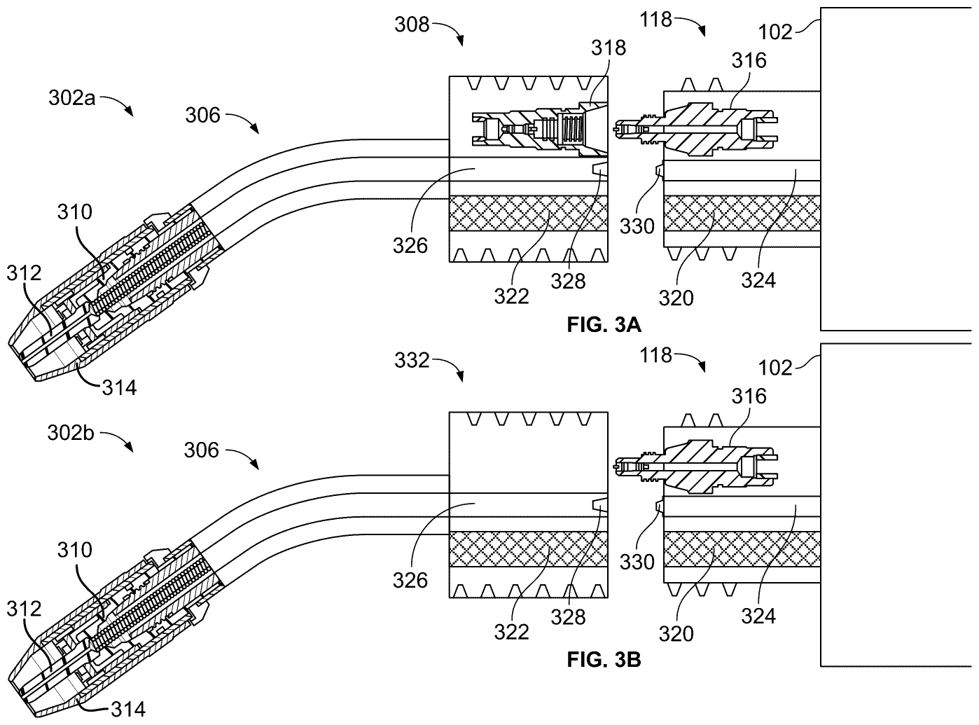

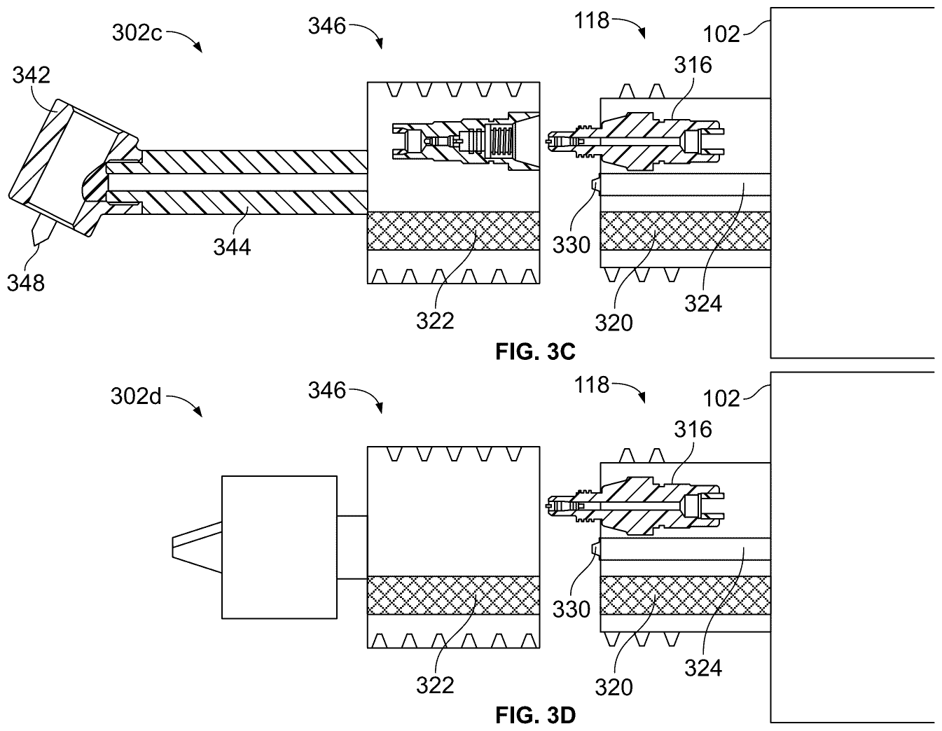

The swappable front assembly 116 may include connections to provide the electric power, shielding gas, and/or welding wire to the welding arc. The swappable front assembly 116 may be attached via a collar, which fastens the swappable front assembly 116 to a corresponding threaded connector 118 on the housing 102. Example front assemblies 116 are disclosed below with reference to FIGS. 3A-3D.

The example ultraportable welding device 100 further includes a work cable 120 for connection to a workpiece as part of the welding circuit.

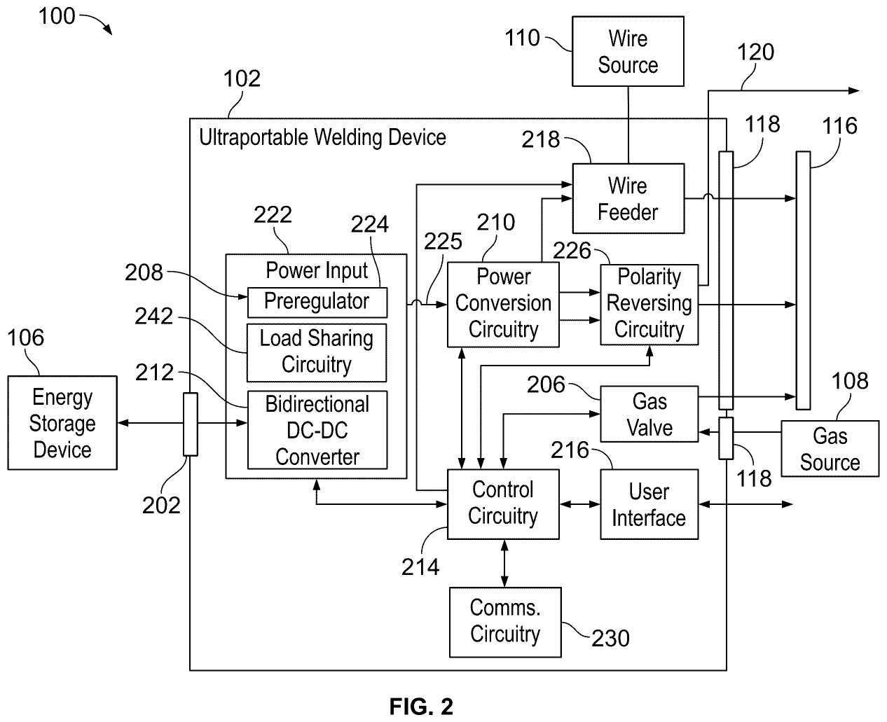

FIG. 2 is a block diagram of the example ultraportable welding device 100 of FIG. 1. The example ultraportable welding device 100 of FIG. 1 includes the housing 102, the energy storage device 106, the gas port 112, the wire spool holder 114, and the threaded connector 118.

In addition to the energy storage device 106, the ultraportable welding device 100 may also be connected to utility power 208 (e.g., or mains power, or other type of AC input) from a power source such as an engine-driven generator, a battery-powered inverter supply, and/or any other power source. The ultraportable welding device 100 may be powered by either or both of the energy storage device 106 or the utility power 208 at any given time.

When the ultraportable welding device 100 is connected to both the AC input power 208 and to the energy storage device 106, the ultraportable welding device 100 may use the AC input power 208 as a leading power source and/or may charge the energy storage device 106 using the AC input power 208. Conversely, when energy is required that is not available from the utility power 208, the energy storage device 106 may provide power to the ultraportable welding device 100 (e.g., to increase the available output power). The energy storage device 106 may be detachably connected to the housing 102 via an energy storage device connector 202.

The ultraportable welding device 100 includes power conversion circuitry 210, a bidirectional DC-DC converter 212, control circuitry 214, a user interface 216, and a wire feeder 218. In some examples, the bidirectional DC-DC converter 212 may be replaced with a single unidirectional DC-DC converter (e.g., embodiments in which ultraportable welding device 100 does not have an AC power input) and/or multiple unidirectional DC-DC converters (e.g., a first converter to convert in a first direction and a second converter to convert in a second direction).

The power conversion circuitry 210 is a circuit that converts direct current (DC) power to welding power 220. The DC power used by the power conversion circuitry 210 is received from a power input 222. The power input 222 includes a preregulator 224 and/or the bidirectional DC-DC converter 212, and supplies one or more intermediate DC buses 225 with energy (e.g., a DC bus for the output of the preregulator 224 and one or more DC buses for the output of the bidirectional DC-DC converter 212, one DC bus for each battery connection, etc.). The preregulator 224 may include a rectifier to rectify the AC input from the utility power 208, pre-charging circuitry to provide an initial charge to the DC bus 225, power factor correction circuitry, and/or any other desired circuitry. The preregulator 224 further includes circuitry to convert the rectified AC input to the intermediate voltage on the DC bus 225 for providing power to the power conversion circuitry 210.

In some examples, the power input 222 is omitted, and the energy storage device 106 provides power directly to the power conversion circuitry 210.

The power conversion circuitry 210 converts the energy present at the DC bus 225 (e.g., from the power input 222, from the energy storage device 106) to a weld output. For example, the power conversion circuitry 210 may include a switched mode power supply, which is controlled by the control circuitry 214 based on specified weld parameters and feedback.

The example control circuitry 214 includes at least one controller or processor that controls the operations of the ultraportable welding device 100. The control circuitry 214 receives and processes multiple inputs associated with the performance and demands of the system. The control circuitry 214 may include one or more microprocessors, such as one or more “general-purpose” microprocessors, one or more special-purpose microprocessors and/or ASIC S, and/or any other type of processing device. For example, the control circuitry 214 may include one or more digital signal processors (DSPs). The example control circuitry 214 includes one or more volatile and/or non-volatile storage device(s) and/or memory (e.g., RAM, ROM, flash memory, a hard drive, and/or any other suitable optical, magnetic, and/or solid-state storage medium, and/or a combination thereof).

Different welding operations that may be performed using the different front assemblies 116 may use both positive electrode polarity (DCEP), negative electrode polarity (DCEN), and/or alternative polarity. To support different output polarities, the example ultraportable welding device 100 includes polarity reversing circuitry 226 coupled to the output of the power conversion circuitry 210. The polarity reversing circuitry 226 controls the polarity of the welding power output from the power conversion circuitry 210, such as by selectively reversing the polarity output by the power conversion circuitry 210 for delivery to the front assembly 116. The operation of the polarity reversing circuitry 226 may be manual (e.g., via the user interface 216 or other manual configuration) and/or automatic. For example, the control circuitry 214 may control the polarity reversing circuitry 226 based on an input from the user interface 216 specifying the welding process, an input from the user interface 216 specifying the polarity, automatic detection of the connected front assembly 116 (e.g., an identification resistor value of the front assembly), and/or any other detection techniques.

The bidirectional DC-DC converter 212 is a circuit that converts input power (e.g., from the DC bus 225 powered by the utility power 208) to charge the energy storage device 106. The bidirectional DC-DC converter 212 also converts the stored power in the energy storage device 106 to converted power to output to the power conversion circuitry 210 (e.g., via one or more DC buses 225) for output to the power conversion circuitry 210.

The control circuitry 214 controls the power conversion circuitry 210 to output the weld output. The control circuitry 214 controls the bidirectional DC-DC converter 212 to convert power from the power input 222 to charge the energy storage device 106 and/or controls the bidirectional DC-DC converter 212 to convert power from the energy storage device 106 to provide the converted battery power to the power conversion circuitry 210. The control circuitry 214 further controls the bidirectional DC-DC converter 212 to charge the energy storage device 106 when the utility power 208 is available and at least a portion of the utility power 208 is available for charging the energy storage device 106 (e.g., the utility power 208 is not completely consumed by the power conversion circuitry 210 and/or the wire feeder 218). Conversely, the control circuitry 214 controls the bidirectional DC-DC converter 212 to convert power from the energy storage device 106 to provide the converted battery power to the power conversion circuitry 210 when a demand for welding power is higher than can be provided by the utility power 208.

The example wire feeder 218 includes a wire feed motor to provide electrode wire from the wire source 110 to the welding operation (e.g., when the welding operation involves a wire feeder, such as when gas metal arc welding, flux cored arc welding, etc.). When the welding operation involves a wire feeder, the control circuitry 214 controls the wire feeder 218. For example, the control circuitry 214 may control the wire feeder 218 based on detecting that a front assembly 116 configured to perform a wire-fed welding process is connected to the connector 118 of the housing 102.

The wire feeder 218 is powered by the power conversion circuitry 210. In some examples, a power line that powers the wire feeder 218 is routed through the connector 118 and include an open circuit. In such examples, the front assemblies 116 configured to perform a wire fed welding process are configured to close the open circuit when connected to the connector 118, allowing the wire feeder 218 to be powered during wire-fed welding processes, while front assemblies 116 which are directed to non-wire-fed processes do not close the power connection to the wire feeder 218.

The example ultraportable welding device 100 further includes a gas valve 206 coupled to the gas source 108. The gas valve 206 is internal to the housing 102, and controls the flow of the shielding gas from the gas source 108 to the front assembly 116 via the connector 118. In some examples, the gas valve 206 includes a contactor or other switching device which is actuated to turn gas on and off, as well as a manually or automatically adjusted flow control valve. In other examples, the connector 118 includes a valve, such as a Schrader valve, that is actuated by connection of a corresponding actuator on the front assemblies 116 for welding processes which use shielding gas. Such front assemblies 116 actuate the Schrader valve to enable flow of shielding gas from the gas source 108 to the front assembly 116 via the connector 118.

The user interface 216 enables input to the ultraportable welding device 100 and/or output from the ultraportable welding device 100 to a user. The user interface 216 may indicate the state of charge of the energy storage device 106 and/or a mode of operation, such as a battery charging mode, an external power welding mode (e.g., welding mode powered by utility power), a combination welding-charging mode (e.g., welding and charging the energy storage device 106 using utility power 208), a battery powered welding mode, or a hybrid welding mode (e.g., welding boost mode powered by utility power and battery power), of the ultraportable welding device 100 via the user interface 216.

The user interface 216 may include inputs to allow an operator to specify welding parameters, such as a workpiece thickness, output voltage, output current, wire feed speed, welding wire diameter, welding wire type, welding process, polarity, and/or any other parameters. The control circuitry 214 may automatically determine at least one of the weld parameters based on a selection of a second one of the welding parameters via an input device of the user interface 216. For example, the control circuitry 214 may automatically determine a voltage based on a wire feed speed selected via the user interface 216, or vice versa. Additionally or alternatively, the control circuitry 214 may automatically select a voltage and wire feed speed based on physical weld parameters such as material thickness, wire type, wire size, and/or shielding gas type. In some examples, the user interface 216 may be implemented using a remote control device, such as a smartphone or other computing device, that is communicatively coupled to communication circuitry 230 of the ultraportable welding device 100. The communication circuitry 230 may implement any wired and/or wireless communications protocols to communicate with desired devices.

The example control circuitry 214 monitors the properties of the connected energy storage device 106 and/or utility power 208 to provide information about the energy storage device 106, utility power 208, and welding capacity to the operator. For example, as the power available to the power input 222 from the energy storage device 106 increases, the control circuitry 214 may determine that thicker materials can be welded, a longer time, length, and/or number of welds of a given length are available to weld for a given set of parameters, use of the utility power 208 can be decreased, the types of usable weld processes increases, the usable consumable sizes (e.g., electrode diameters) increase, and/or other enhancements and/or augmentations to welding may become available. Conversely, as the power available from the energy storage device 106 decreases, the control circuitry 214 may determine that the thickness of materials that can be welded decreases, less time is available to weld for a given set of parameters, more utility power 208 may be needed, the types of usable weld processes are limited, the usable consumable sizes (e.g., electrode diameters) decrease, and/or the ultraportable welding device 100 becomes otherwise limited.

The control circuitry 214 receives and uses properties of the energy storage device 106 to determine welding capacity and supported values for welding parameters, and to control the conversion of battery power by the bidirectional DC-DC converter 212 to supply the DC bus 225. For example, the control circuitry 214 may control the DC-DC converter 212 to convert a first output voltage from the energy storage device 106 to an intermediate voltage of the DC bus 225 based on one or more properties of the energy storage device 106.

The example power input 222 may further include load sharing circuitry 242. The load sharing circuitry 242 controls a balance of power input from the utility power 208 and the energy storage device 106. For example, the control circuitry 214 may control the load sharing circuitry 242 to cause relatively more power to be drawn from the utility power 208 to preserve stored energy and/or avoid unnecessary discharge. The control circuitry 214 may also control the load sharing circuitry 242 to cause relatively more power to be drawn from the energy storage device 106, such as to reduce high electricity costs and/or save fuel when utility power 208 is powered by an engine-driven (or other portable fuel-driven) source.

While the example energy storage device 106, the example gas source 108, and the example wire source 110 are illustrated in FIG. 1 as mounted or directly attached to the housing 102, in other examples one or more of the energy storage device 106, the gas source 108, and/or the wire source 110 are separate from the housing 102, and supply the electric power, gas, and/or wire via individual or combined cables connected to the housing 102. For example, the energy storage device 106, the gas source 108, and/or the wire source 110 may be mounted to a belt, backpack, or other apparel or carrier worn by the operator, and the ultraportable welding device 100 is connected to the belt (or other carrier) and handled by the operator. In such cases, the power conversion circuitry 210, the gas valve 206, and the wire feeder 218 remain within the housing 102 to maintain ultraportability of the system.

As mentioned above, the ultraportable welding device 100 supports two or more welding process using swappable front assemblies 116. FIGS. 3A-3D illustrate example implementations of front assemblies 302a-302d for different welding processes.

FIG. 3A illustrates an example front assembly 302a for a wire-fed welding process which uses shielding gas (e.g., GMAW). The front assembly 302a includes a contact tip assembly 304, a neck 306, and a front assembly connector 308.

The neck 306 extends from the housing 102 toward the weld, and conducts the welding wire (e.g., via a wire liner within the neck 306), electrical current (e.g., via conductors within the neck 306), and shielding gas to the contact tip assembly 304. The neck 306 may be straight, may include a fixed bend angle, or may have a rotatable and/or flexible bend angle which is configurable by the operator to position the contact tip assembly 304 with respect to the housing 102.

The example contact tip assembly 304 includes a gas diffuser 310, a contact tip 312, and a nozzle 314. The gas diffuser 310 is coupled to the neck 306 for delivery of the shielding gas, electrical current, and welding wire. The contact tip 312 conducts electrical current from the gas diffuser 310 to the welding wire as the wire passes through a bore of the contact tip 312. The nozzle 314 directs shielding gas expelled from the gas diffuser 310 toward the location of the weld.

Example contact tip assemblies that may be used to implement all or a portion of the contact tip assembly 304 are disclosed in: U.S. Pat. No. 9,669,486, granted Jun. 6, 2017; U.S. Pat. No. 11,391,574, granted Nov. 8, 2022; U.S. Pat. No. 8,633,422, granted Jan. 21, 2014; U.S. Patent Application Publication No. 2017/0165780, filed Dec. 12, 2016; and U.S. Pat. No. 10,773,332, granted Aug. 31, 2016. Other implementations may also be used. The entireties of U.S. Pat. Nos. 9,669,486, 11,391,574, 8,633,422, U.S. Patent Application Publication No. 2017/0165780, U.S. Pat. No. 10,773,332 are incorporated herein by reference.

To selectively supply the shielding gas to the front assemblies 116, the example housing connector 118 includes a gas valve 316 which can be actuated by a corresponding valve seat 318 of the front assembly connector 308 of the front assembly 302a. For example, the gas valve 316 may be a Schrader-type valve which seals gas flow when in a default or resting position and allows gas to flow when the stem of the gas valve 316 is moved out of a sealing position. The valve seat 318 may include a projection or other feature to unseat the stem of the gas valve 316 when the front assembly connector 308 is connected to the housing connector 118.

The housing connector 118 supplies electrical current to the front assemblies 116 via one or more conductors 320, which are configured to conduct welding current to corresponding conductor(s) 322 of the front assemblies 116. The conductor(s) 322 extend through the neck 306 to the contact tip assembly 304. The conductors 322 may contact the conductors 320 via any type of connectors, pins, facial contact, and/or other type of electrical contact.

To selectively supply welding wire to the front assemblies 116, the housing connector 118 includes a wire conduit 324 which aligns with a corresponding wire conduit 326 of the front assembly 302a. The example wire conduit 326 may include a tapered wire inlet 328 which improves alignment with a tapered outlet 330 of the wire conduit 324. As mentioned above, the connection of the housing connector 118 and the front assembly connector 308 of front assemblies 302a, 302b configured to wire-fed processes may close or complete a power circuit to allow the wire feeder 218 to be powered during operation.

The housing connector 118 and the front assembly connector 308 each include respective threads to secure the front assembly 302a to the housing connector 118. The front assembly connector 308 may include keying features to align the gas valve 316 with the seat 318, align the wire conduits 324, 326, and/or align the conductors 320, 322.

FIG. 3B illustrates an example front assembly 302b for a gasless wire-fed welding process (e.g., FCAW). The front assembly 302b is similar to the front assembly 302a of FIG. 3A, including the contact tip assembly 304 and the neck 306. The front assembly 302b further includes a front assembly connector 332 configured to connect to the housing connector 118. However, because the front assembly 302b is for a gasless welding process, the example front assembly connector 332 includes the wire conduit 326 and the conductor 322, and omits the seat 318 that actuates the gas valve 316. The housing connector 118 delivers welding wire and electric power to the front assembly 302b, but does not convey shielding gas.

FIG. 3C illustrates an example front assembly 302c for a tungsten electrode welding process which uses shielding gas (e.g., GTAW). The example front assembly 302c includes a tungsten electrode holding assembly (e.g., a welding head 342), a neck 344, and a front assembly connector 346.

The front assembly connector 346 is configured to connect to the housing connector 118. The GTAW welding process supported by the front assembly 302c uses shielding gas, but does not use welding wire. The example front assembly connector 346 includes the gas seat 318 and the conductor 322, and omits the wire conduit 326. The housing connector 118 delivers shielding gas and electric power to the front assembly 302c, but does not convey welding wire. For example, the power connection for delivery of power to the wire feeder 218 may be open-circuited at the housing connector 118, where the front assembly connector 346 does not close the circuit, which prevents the wire feeder 218 from feeding wire to the front assembly 302c which is unable to further convey the welding wire.

The welding head 342 supports a tungsten electrode 348 in electrical conduction with the front assembly connector 346 via the neck 344. The welding head 342 may position the tungsten electrode using a collet or other type of electrode support. The neck 344 conducts electrical current and shielding gas from the front assembly connector 346 to the welding head 342.

FIG. 3D illustrates an example front assembly 302d for a gasless stick welding process (e.g., SMAW). The example front assembly 302d includes a stick electrode holding assembly (e.g., a chuck 352), a neck 354, and a front assembly connector 356.

The front assembly connector 356 is configured to connect to the housing connector 118. The SMAW welding process supported by the front assembly 302d uses electrical current, but does not use either shielding gas or welding wire. The example front assembly connector 356 includes the conductor 322, and omits both the seat 318 and the wire conduit 326. The housing connector 118 delivers the electric power to the front assembly 302d, but does not convey welding wire or shielding gas.

The chuck 352 is configured to releasably hold a stick electrode, and is in electrical contact with the conductor 322 via the neck 354. The chuck 352 may be at least partially constructed with brass, copper, or other low resistivity material. In some other examples, the contact tip assembly 304 of FIGS. 3A and 3B, and/or the welding head 342 of FIG. 3C, may be modified to hold a stick electrode instead of a welding wire or tungsten electrode. For example, a contact tip and/or collet may be installed into the contact tip assembly 304 to hold a stick electrode instead of conveying welding wire, and/or a collet or other fixture may be installed into the welding head 342 of FIG. 3C to hold a stick electrode instead of the tungsten electrode 348.

The neck 354 may have a specific angle and/or length with respect to the housing 102, and/or may be flexible to allow the operator to configure a desired angle. In some other examples, the chuck 352 may be connected directly to the front assembly connector 356, omitting the neck 354.

While example front assemblies 116 and housing connectors 118 are disclosed above, in other examples the front assemblies 116 and housing connectors 118 may be implemented using one or more features of the electrical, gas, and/or wire connections disclosed in U.S. Pat. No. 11,189,942, granted Nov. 30, 2021. The entirety of U.S. Pat. No. 11,189,942 is incorporated herein by reference.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A handheld welding device, comprising:
an energy storage device;
power conversion circuitry configured to convert input power from the energy storage device to output welding power;
at least one of:
a wire feeder configured to deliver welding wire; or
a gas valve configured to control flow of gas from a gas source;
a front assembly configured to conduct the welding power to a welding electrode, wherein the front assembly is swappable between two or more of a wire-fed welding process, a stick welding process, or a tungsten electrode welding process;
control circuitry configured to control the power conversion circuitry and the at least one of the wire feeder or the gas valve based on the configured one of the two or more welding processes, to selectively provide the welding power and at least one of the welding wire or the gas to the front assembly in response to an input device; and
a housing, wherein the power conversion circuitry, the at least one of the wire feeder or the gas valve, and the control circuitry are integral to the housing, and the energy storage device is integral or detachably attached to the handheld welding device.

2. The handheld welding device as defined in claim 1, wherein the housing comprises a handle and a connector connecting the handle to the front assembly.

3. The handheld welding device as defined in claim 2, wherein the energy storage device is attached external to the housing.

4. The handheld welding device as defined in claim 2, further comprising a wire supply attached external to the housing.

5. The handheld welding device as defined in claim 1, further comprising a wire supply separate from and coupled to the handheld welding device, wherein the wire feeder is configured to pull the welding wire from the wire supply.

6. The handheld welding device as defined in claim 1, wherein the front assembly comprises a gas nozzle, a diffuser, and a contact tip, wherein the diffuser and the contact tip provide a current path from the power conversion circuitry to the welding wire.

7. The handheld welding device as defined in claim 1, wherein the front assembly is configured to alternately hold a stick electrode.

8. The handheld welding device as defined in claim 1, wherein the front assembly is replaceable with a stick electrode holding assembly.

9. The handheld welding device as defined in claim 1, wherein the front assembly is replaceable with a tungsten electrode holding assembly.

10. The handheld welding device as defined in claim 1, further comprising polarity reversing circuitry configured to control a polarity output by the power conversion circuitry.

11. The handheld welding device as defined in claim 1, further comprising one or more input devices configured to control at least one of a welding process, an amperage parameter, a voltage parameter, or a wire feed speed parameter.

12. The handheld welding device as defined in claim 1, wherein the control circuitry is configured to determine at least one weld parameter based on a selection of a second welding parameter via the one or more input devices.

13. The handheld welding device as defined in claim 1, further comprising a power input configured to receive input power from a power source, and a preregulator configured to convert the input power from the power source to a DC power, and to provide the DC power to the power conversion circuitry.

14. A handheld welding device, comprising:
an energy storage device;
power conversion circuitry configured to convert input power from the energy storage device to output welding power;
a wire feeder configured to deliver welding wire;
a front assembly configured to conduct the welding power to a welding electrode, wherein the front assembly is swappable between two or more of a wire-fed welding process, a stick welding process, or a tungsten electrode welding process;
control circuitry configured to control the power conversion circuitry based on the configured one of the two or more welding processes, to selectively provide the welding power to the front assembly in response to an input device; and
a housing, wherein the power conversion circuitry, the wire feeder, and the control circuitry are integral to the housing, and the energy storage device is integral or detachably attached to the handheld welding device.

15. The handheld welding device as defined in claim 14, wherein the housing comprises a handle and a connector connecting the handle to the front assembly.

16. The handheld welding device as defined in claim 15, wherein the energy storage device is attached external to the housing.

17. The handheld welding device as defined in claim 15, further comprising a wire supply attached external to the housing.

18. The handheld welding device as defined in claim 14, further comprising a wire supply separate from and coupled to the handheld welding device, wherein the wire feeder is configured to pull the welding wire from the wire supply.

19. The handheld welding device as defined in claim 14, wherein the front assembly comprises a gas nozzle, a diffuser, and a contact tip, wherein the diffuser and the contact tip provide a current path from the power conversion circuitry to the welding wire.

20. The handheld welding device as defined in claim 14, wherein the front assembly is configured to alternately hold a stick electrode.
